(19) United States
(12) Patent Application Publication
(10) Pub. No.: US 2010/0082628 A1
(43) Pub. Date: Apr. 1, 2010

(54) Classifying A Data Item With Respect To A Hierarchy Of Categories

(76) Inventor: Martin Scholz, San Francisco, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/243,051

(22) Filed: Oct. 1, 2008

(51) Int. Cl. G06F 7/06; G06F 17/30

(52) U.S. Cl. 707/740; 707/E17.046; 707/E17.014

(57) ABSTRACT

To classify an input data item, a hierarchy of categories is provided. A classifier is used to identify, from a set of data items, neighboring data items of the input data item. According to metric values relating the neighboring data items to the input data item, it is determined whether at least one category is assignable to the input data item from among the hierarchy of categories. The determining involves processing the hierarchy from more specific categories to less specific categories.

### BACKGROUND

It is often desirable to classify various types of information. In one example application, automated classification of web content can be useful for various purposes, such as to understand information provided by websites, to categorize websites, to perform management tasks with respect to the websites, and so forth. In other applications, classification of other types of content can be performed.

Although various classification techniques exist for classifying information, it is noted that many of these conventional classification techniques may suffer various drawbacks,

### BRIEF DESCRIPTION OF THE DRAWINGS

Some embodiments of the invention are described with respect to the Following figures:

FIG. 1 is a block diagram of an example computer in which an embodiment of the invention can be incorporated;

FIG. 2 is a flow diagram of providing a corpus of labeled examples and providing an index to enable k nearest neighbor classification, according to an embodiment.

FIG. 3 is a flow diagram of performing k nearest neighbor classification with respect to a hierarchy of categories, according to an embodiment; and

FIG. 4 shows an example hierarchy of categories with which classification according to some embodiments cam be performed.

### DETAILED DESCRIPTION

In accordance With some embodiments, a technique of classifying a data item includes defining a hierarchy of categories, and classifying the data item with respect to the hierarchy of categories. In some embodiments, k nearest neighbors (k-NN) classification is performed, which is classification to find the k (k·1) nearest data items (based on some similarity metric or similarity measure) to a data item of interest. More generally, the k-NN classification attempts to find the neighboring data items of the data item of interest, where a “neighboring” data item refers to a data item related to the data item of interest by some metric. The classification is performed in a bottom-up manner in the hierarchy of categories. By performing the classification in a bottom-up manner rather than a top-down manner with respect to the hierarchy of categories, enhanced accuracy in classification can be achieved.

A “hierarchy of categories” refers to a multi-level arrangement of categories, where a higher-level category can have child categories that are related to the higher-level category. A bottom-up approach of classification refers to classification that attempts to select a lower-level category to classify data before proceeding to a higher-level category. In the hierarchy, higher level categories are more general categories, whereas lower level categories are more specific categories. A more specific category in the hierarchy is a category that encompasses a smaller number of data items than a more general category (less specific category,

By performing classification starting from the bottom of the hierarchy and proceeding upwardly, the classification is able to select a more specific category (or categories) for classifying data when possible. Although reference is made to performing classification in a bottom-up manner with respect to a hierarchy of categories, it is noted that “bottom-up” is intended to refer to a direction from more specific categories to more general categories. For example, if a hierarchy of categories is depicted upside down, “bottom-up” refers to “top-down,” and “higher” would refer to “lower” (and vice versa). Thus, generally, a hierarchy of categories is processed in a direction from more specific categories to less specific categories in performing the classification.

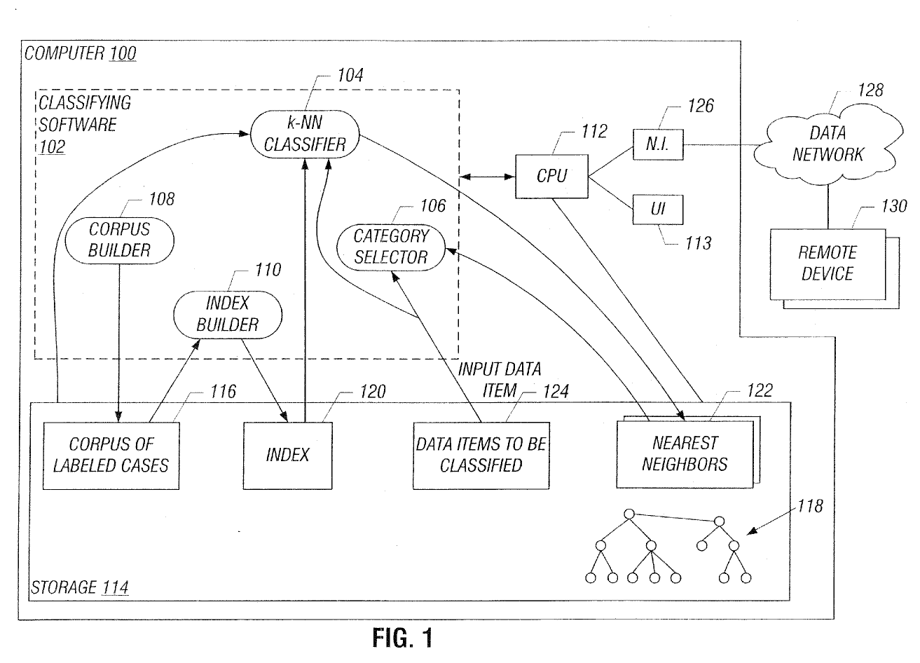

FIG. 1 illustrates an example system that includes a computer 100 in which classifying software 102 according to some embodiments is executable. The classifying software 102 includes various modules, including a k-NN classifier 104, a category selector 106, a corpus builder 108, and an index builder 110. Instead of being in separate modules as depicted in FIG. 1, it is noted that one or more of the modules depicted in FIG. 1 can be combined.

The classifying software 102 is executable on one or more central processing units (CPUs) 112. Also, the CPU 112 is connected to storage 114 in the computer 100, where the storage 114, e.g., non-persistent memory (such as dynamic random access memories) or persistent storage (such as disk storage medium), can store various data structures.

The corpus builder 108 is able to build a corpus of labeled data items 116, which is a collection of data items that are labeled with respect to categories, such as categories in a hierarchy 118 of categories which can also be stored in the storage 114). From the corpus of labeled data items 116, the index builder 110 is able to build an index 120, such as a full text index or other type of index, to map features associated with the labeled data items to a data item to be classified (124). For example, each data item can be represented as a bag of words (set of words). Given an input bag of words (corresponding to a data item to be classified), the index 120 can be accessed to retrieve matching data items.

The index 120 is used by the k-NN classifier 104 to find the k nearest neighbors (from the corpus of data items 116) of an input data item that is to be classified. The nearest neighbors for any input data item is represented as 122 in FIG. 1. In some embodiments, k·1. More specifically, k·2.

The nearest neighbors 122, as identified by the k-NN classifier 104, is provided as an input to the category selector 106, which also receives the input data item to be classified. Given the k (k·1) nearest neighbors, which are data items that are labeled with respect to categories, the category selector 106 is able to identify one or more categories (or no category) from the hierarchy 118 of categories to assign to the input data item that is to be classified. In selecting the one or more categories (or no category) that are to be assigned to the input data item, the category selector 106 uses one or more confidence weights or indicators (discussed further below).

The CPU(s) 112 is (are) connected to a network interface 126, which allows the computer 100 to communicate over a data network 128 with one or more remote devices 130. For example, the computer 100 can be a server computer, and a remote device 130 can be a client computer. The client computer can submit an input data item to the computer 100 for classification, and the computer 100 can then return an output indicating the category (or categories) assigned to the input data item. Note also that the server computer 100 can indicate that no category has been assigned to the data item.

The remote device 130 can include a display 132 in which the output provided by the computer 100 can be displayed. Alternatively, instead of displaying output of the classifying software 102 in the display 132 of the remote device 130, the computer 100 itself can have a display device in which the output of the classifying software 102 can be displayed.

In some implementations, the data items to be classified (124) include web content (such as web pages or other content associated with one or more websites). Web content can be in the form of web documents (e.g., hypertext markup language or HTML documents, extensible markup language or XML documents, etc.) that describe respective web content. In such examples, the remote devices 130 can be web servers, and the computer 100 can monitor web documents that are provided by the remote devices 130.

Alternatively, the data items to be classified (124) can be other types of data items, such as text documents, image documents, audio documents, video documents, business documents, and so forth.

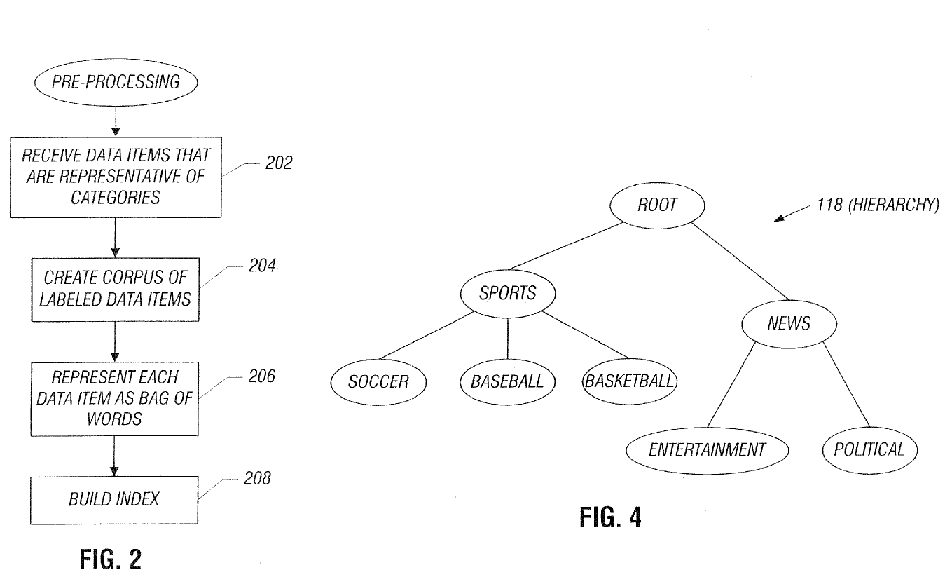

FIG. 2 shows a pre-processing procedure for building the corpus of labeled data items 116 and the index 120. The corpus builder 108 in the classifying software 102 receives (at 202) data items that are representative of categories in the hierarchy 118 of categories. In one embodiment, a user may have submitted a query for each of the categories in the hierarchy 118 of categories. The queries that are submitted can contain words derived directly from the names of the categories in the hierarchy 118. The queries can be Internet search engine queries that are submitted to an Internet search engine (or multiple Internet search engines) to identify search results based on the queries. Alternatively, the queries can be database queries that are submitted to a database system (or multiple database systems) for identifying data items relating to the queries.

In one example, as depicted in FIG. 4, it is assumed that the hierarchy 118 includes an intermediate category called “sports”. Under the intermediate “sports” category more specific categories (lower-level categories or subcategories) can include the following: “soccer,” “baseball,” “basketball,” as examples. The hierarchy 118 depicted in FIG. 4 can also include an intermediate “news” category that has subcategories “entertainment” and “political.” In such an example, a web query that can be submitted to identify data items related to “soccer” can include the word “soccer” as well as possibly other words surrounding “soccer.” The search results of the web query would provide data items that are related to the category “soccer.” Similar web queries can be submitted for other categories in the hierarchy 118.

From the search results, a corpus of labeled data items 116 can then be created (at 204) by the corpus builder 108. Thus, the data items from search results responsive to the web query for “soccer” can be labeled with the category “soccer”; the data items from the search results responsive to the web query for “baseball” can be labeled with the category “baseball”; the data items from the search results responsive to the web query “entertainment” or “entertainment news” can be labeled with “entertainment”; and so forth.

Note that the search results for any web query can be relatively large. The data items that are selected for addition to the corpus of labeled data items 116 are the highest ranks (e.g. top ten, top twenty, etc.) search results for each given web query.

Instead of using a query-based technique of building up a corpus of labeled data items 116, another technique can involve a user (or users) manually providing example data items that are labeled with respect to categories of the hierarchy 118 to the corpus builder 108. As yet another example, feeds from various sources relating to different categories can be used for building up the corpus of labeled data items 116. For example, the feeds can be RSS (RDF site summary) feeds, which are web-based feeds that publish frequently-updated content such as blog entries, news headlines, podcasts, and so forth. RSS content can be read using an RSS reader, feed reader, or an aggregator. A subscription can be made to various sites that provide RSS feeds, such as Wikipedia, Yahoo, and so forth. Data items received from the one or more sources can be labeled with categories based on types of data received from the one or more sources.

As yet another example, data items that can be added to the corpus of labeled data items 116 can be data items from on online encyclopedia, such as Wikipedia or some other type of online encyclopedia.

Once the corpus of labeled data items 116 is created, the index builder 110 processes each data item from the corpus or labeled data items 116 to represent (at 206) each data item as a bag of words. Note that various features are removed from each data item prior to building up such a bag of words to represent the data item. For example, stop words, can be removed. Stop words are common words such as “the,” “a,” “of,” etc., that are not useful for purposes of classifying since they are likely to occur in all documents or a vast majority of documents. Also, if the data items are web documents, then tags, such as HTML tags, XML tags, etc., are removed prior to developing the bag of words to represent the data item. Also, stemming can be performed to reduce a word to its stem. For example, “hitting” would be reduced to “hit,” “stopping” would be reduced to “stop,” “stopped” would be reduced to “stop,” and so forth. Stemming is a process of reducing inflected (or sometimes derived) words to their stem, base, or root form. For example, “fishing,” “fished,” “fish,” and “fisher” would be reduced to the root word “fish.”

Also, if appropriate, plain text can be tokenized prior to developing a bag of words to represent each data item. Tokenization refers to breaking down a stream of characters (e.g., ASCII characters) into words. Typically, white spaces, periods, colons, etc., mark the beginning and end of a sentence. The tokenizer looks for these delimiters to extract words in between the delimiters as the elementary units for subsequent preprocessing tasks, such as stop word removal, stemming, and so forth.

Once each data item has been represented as a bag of words, the index builder 110 can build (at 208) the index 120, such as a full text index. In some embodiments, the index 120 is basically a reverse index that can accept as an input a bag of words and to produce as an output data items (from the corpus of labeled data items 116) that are of sufficient similarity to the bag of words, where “sufficient similarity” can be predefined based on the use of thresholds for a metric (e.g., cosine similarity measure) that represents how closely related each of the data items from the corpus of labeled data items 116 is to the input bag of words. The index 120 can be in various forms, such as in table form, in tree form, and so forth. The data items from the corpus 116 that are of “sufficient similarity” are the k nearest neighbors, as identified by the k-NN classifier 104.

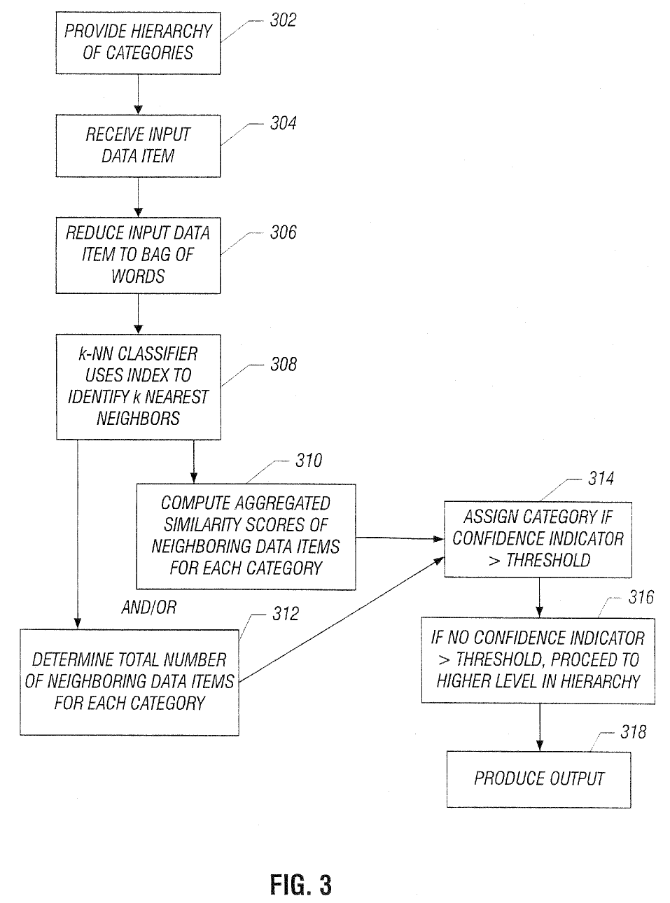

FIG. 3 illustrates the process of classifying an input data item (from the data items to be classified 124 in FIG. 1). The process includes the provision (at 302) of the hierarchy of categories. The classifying software 102 next receives (at 304) the input data item that is to be classified. The input data item is reduced (at 306) to a bag of words. The classifying software 102 invokes the k-NN classifier 104, which uses (at 308) the index 120 to identify, for the bag of words, the k nearest neighbors from the corpus of labeled data items 204, based on one or more predefined metrics.

The k closest neighbors include data items that may be labeled with one or more other categories of the hierarchy 118. Thus, in the example of FIG. 4, the k nearest neighbors can include data items relating to the categories “soccer” and “baseball,” as well as data items relating to the category “entertainment”. Given these k nearest neighbors, the category selector 106 has to determine which (if any) of the categories represented by the k nearest neighbors are relevant.

As noted above, in identifying the k nearest neighbors, some metric, such as the cosine similarity measure, is used. The category selector 106 computes (at 310) aggregated similarity scores of the identified nearest neighbor data items for each specific category. For example, if three data items labeled to “soccer” were identified in the k nearest neighbors, then the cosine similarity measures for these three data items can be aggregated to produce an aggregate measure (which is one example of an aggregated similarity score) for the category “soccer.” Similarly, if five data items labeled with the category, “baseball” were among the nearest neighbors, then the cosine similarity measures for these data items would be aggregated to produce an aggregate measure for category “baseball.” This is repeated for each of the other categories represented by the k nearest neighbors identified by the k-NN classifier 104. Effectively, the k nearest neighbors of the input data item are divided into plural groups, where each group corresponds to a respective labeled category (the category that the data items in the group are labeled with). For each group, the measures of the data items (as computed by the k-NN classifier 106) are aggregated (an aggregate can be a sum, average, median, maximum, minimum, etc.) to produce an aggregate similarity score for the category, associated with the group.

The aggregate similarity scores can be used as confidence weights (or indicators) for each category associated with the k nearest neighbors. The confidence weights can then be compared to some predefined threshold to identify one or more categories (if any) whose aggregate similarity score(s) exceed (greater than or less than depending on whether a higher value or lower value of the aggregate measure is more indicative of a closer relationship) the predefined threshold. Based on the confidence weights and the relationship to the predefined threshold, the category selector 106 is able to select (at 314) one or more categories (or no category) associated with similarity score(s) exceeding the threshold.

Instead of using aggregate similarity scores computed from an aggregate of the cosine similarity measures, a different confidence indicator can be used. For example, the total number of data items (from the k nearest neighbors) within each category is determined (at 312). For example, the k nearest neighbors identified for the input data item may have two data items in category “soccer,” six data items in category “baseball,” and one data item in category “political.” The total number within each category, can then be used as a confidence weight. If the total number is greater than a predefined threshold, then that corresponding category can be selected for the input data items.

In yet another embodiment, both the aggregated measures and total numbers of data items can be used as indications of relevance of a category to the input data item.

Note that it may be the case that there is no confidence weight (from among the confidence weights associated With the categories of the data items in the k nearest neighbors) greater than the relevant predefined threshold(s). In this case, the categories in the leaf nodes of the hierarchy 118 would not be selected for association with the input data item. Instead, the category selector 106 would move up (at 316) the hierarchy 118 to the next higher level of categories. Then, the aggregate measure or total number of neighbors for each intermediate category at this higher level would be computed and compared to a predefined threshold(s), similar to the process above. Note that the predefined threshold(s) at the different levels of the hierarchy 118 can be different. For example, at a higher category level, it may be desired to set the predefined threshold(s) such that a greater confidence weight would be desirable before identifying the higher-level category with the input data item.

In some cases, the k nearest neighbors may include a relatively large number of data items (greater than another predefined threshold) relating to one category. In this case, the input data item can be assigned the category associated with such a large number of data items with relatively high confidence. This input data item can then be added to the corpus of labeled data items 116, since such input data item would be considered a good example of the corresponding category. This provides a feedback mechanism in which classification performed by the classifying software 102 can enable data items to be added to the corpus of labeled data items 116.

Next, the output is produced (at 318), where the output can be one or more categories from the hierarchy assigned to the input data item, or an indication that no category has been assigned to the input data item.

The tasks of FIGS. 2 and 3 may be provided in the context of information technology (IT) services offered by one organization to another organization. For example, the computer 100 (FIG. 1) may be opined by a first organization. The IT services may be offered as part of an IT services contract, for example.

Instructions of software described above (including classifying software 102 and its modules 104, 106, 108, 110 of FIG. 1) are loaded for execution on a processor (such as one or more CPUs 112 in FIG. 1). The processor includes microprocessors, microcontrollers, processor modules or subsystems (including one or more microprocessors or microcontrollers), or other control or computing devices. As used here, a “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of classifying an input data item, comprising:
providing a hierarchy of categories;
using a classifier to identify, from a set of data items, neighboring data items of the input data item; and
according to metric values relating the neighboring data items to the input data item, determining whether at least one category is assignable to the input data item from among the hierarchy of categories, wherein the determining involves processing the hierarchy from more specific categories to less specific categories.

2. The method of claim 1, wherein processing the hierarchy from more specific categories to less specific categories comprises processing the hierarchy in a bottom-up manner.

3. The method of claim 1, wherein using the classifier comprises using a k nearest neighbor (k-NN) classifier to identify k nearest data items from the set of data items, where k·1.

4. The method of claim 3, wherein identifying the k nearest data items comprises identifying the data items from the set based on the metric values.

5. The method of claim 1, wherein using the classifier comprises using a k nearest neighbor (k-NN) classifier to identify k nearest data items from the set of data items, where k·2.

6. The method of claim 1, wherein the neighboring data items are labeled with one or more categories from the hierarchy of categories, the method further comprising:
computing a confidence indicator for each of the one or more categories of the neighboring data items; and
using the confidence indicators to assign the at least one category to the input data item.

7. The method of claim 6, wherein computing the confidence indicator for each particular category comprises aggregating the metric values of the identified data items labeled with the particular category.

8. The method of claim 6, further comprising:
comparing the confidence indicators to a predefined threshold; and
assigning the at least one category according to the comparing.

9. The method of claim 8, wherein the assigned at least one category comprises the one or more categories whose confidence indicators exceed the predefined threshold.

10. The method of claim 6, wherein computing the confidence indicator for each particular category comprises determining a total number of data items in the particular category.

11. The method of claim 1, further comprising building the set of data items based on submitting queries that relate to the categories in the hierarchy, wherein the queries are web queries submitted to search engines or database queries.

12. The method of claim 1, further comprising:
building the set of data items based on receiving the data items from one or more data sources; and
labeling the data items in the set with the categories from the hierarchy based on respective types of data received from the one or more data sources.

13. The method of claim 1, wherein the data items in the set are labeled with categories from the hierarchy the method further comprising:
adding the input data item to the set in response to determining that the input data item has been classified with a respective category with greater than a predefined confidence threshold.

14. The method of claim 1, further comprising providing information technology services, wherein the providing, using, and determining tasks are part of the information technology services.

15. A method of classifying an input data item, comprising:
building a set of data items labeled with categories from a hierarchy of categories;
identifying data items from the set according to similarity metric values relating the data items of the set to the input data item; and
according to the similarity metric values, determining whether at least one category from the hierarchy of categories is assignable to the input data item, wherein the determining involves processing the hierarchy in a bottom-up manner.

16. The method of claim 15, wherein identifying the data items from the set comprises using a k nearest neighbor (k-NN) classifier to identify k nearest data items from the set, where k·1.

17. An article comprising at least one computer-readable storage medium containing instructions that when executed cause a computer to:
provide a hierarchy of categories;
use a classifier to identify, from a set of data items, neighboring data items of an input data item; and
according to metric values relating the neighboring data items to the input data item, determine whether at least one category is assignable to the input data item from among the hierarchy of categories, wherein the determining involves processing tile hierarchy from more specific categories to less specific categories.

18. The article of claim 17, wherein the classifier comprises a k nearest neighbor (k-NN) classifier, k·1.

19. The article of claim 17, wherein the instructions when executed cause the computer to further:
as part or a feedback mechanism, add the input data item labeled with the at least one category to the set.

20. The article of claim 17, wherein the neighboring data items are labeled With one or more categories from the hierarchy of categories, the instructions when executed causing the computer to further:
compute a confidence indicator for each of the one or more categories of the neighboring data items; and
use the confidence indicators to assign the at least one category to the input data item
